(19) United States
(12) Patent Application Publication
(10) Pub. No.: US 2026/0352662 A1
(43) Pub. Date: Nov. 5, 2026

(54) ARCHITECTURE FOR SELECTIVE USE OF PRIVATE PATHS BETWEEN CLOUD SERVICES

(71) Applicant: Amazon Technologies, Inc., Seattle, WA (US)

(72) Inventors: Kshitij Gupta, Seattle, WA (US); Prashant Kumar Singh, Seattle, WA (US); Robert Laks, Seattle, WA (US); Ravi S Nagayach, Aurora, IL (US); Dharani Sankar Vijayakumar, Palo Alto, CA (US)

(21) Appl. No.: 19/280,862

(22) Filed: Jul. 25, 2025

Related U.S. Application Data
(63) Continuation of application No. 18/342,624, filed on Jun. 27, 2023, now Pat. No. 12,381,878.

(51) Int. Cl. H04L 9/40; H04L 61/4511

(52) U.S. Cl. CPC H04L 63/10; H04L 61/4511; H04L 63/101; H04L 63/108; H04L 63/126

(57) ABSTRACT

Systems and methods are provided for allowing function-initiated traffic of an on-demand code execution system within a cloud provider network to be routed to a private path such based on opt-in settings. An opt-in request may be received indicating a desire of a function invoker to use a private path. Subsequent to the opt-in request, a function invocation request may be received to send communication to a service within the cloud provider network and external to the on-demand code execution system. Subsequent to the function invocation request, a virtual execution environment may be configured to execute the function with mapping of a network-based service to an IP address of a private endpoint. The function is then executed with its traffic sent to the private endpoint.

### INCORPORATION BY REFERENCE TO ANY PRIORITY APPLICATIONS

This application is a continuation of U.S. patent application Ser. No. 18/342,624, entitled “ARCHITECTURE FOR SELECTIVE USE OF PRIVATE PATHS BETWEEN CLOUD SERVICES” and filed on Jun. 27, 2023, the disclosure of which is incorporated herein by reference.

Any and all applications for which a foreign or domestic priority claim is identified in the Application Data Sheet as filed with the present application are hereby incorporated by reference under 37 CFR 1.57.

### BACKGROUND

Computing systems can utilize communication networks to exchange data. In some implementations, a computing system can receive and process data provided by another computing system. For example, a computing system can receive data entered using another computing system, store the data, process the data, and so on.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a block diagram of a cloud provider network in which a managed VPC operates an endpoint manager to selectively use private paths for communications from user-defined code executing in an on-demand code execution system according to some embodiments.

FIG. 2 is a block diagram of a managed virtual private cloud (VPC) where communications from functions invoked via the on-demand code execution system can be routed securely to cloud services by a Domain Name System (DNS) resolver according to some embodiments.

FIG. 3 is a block diagram of a managed VPC where communications from functions invoked via the on-demand code execution system can be routed securely to cloud services by use of a local DNS server according to some embodiments.

FIG. 4 is a flow diagram of an illustrative routine for an on-demand code execution system to determine whether to route traffic from an invoked function through a private path based on whether the function invoker or function owner has opted in to use of private paths according to some embodiments.

FIG. 5 depicts a general architecture of a computing device configured to implement the endpoint manager of FIG. 1 according to some embodiments.

### DETAILED DESCRIPTION

The present disclosure relates to selectively directing traffic from an on-demand code execution system using a private, secure path (e.g., a non-public path within a managed network infrastructure or otherwise using a private internet protocol (IP) address that is not visible to the public internet), or permitting the traffic to be routed using a public or unsecured path (e.g., a route over the public internet or otherwise using a public IP address). As used herein, the terms “private path” and “secure path” are used interchangeably to refer to sending packets using IP addresses for source and destination that are not public IP addresses, and to using routes that do not have connectivity outside of the managed network infrastructure (e.g., sending packets though a gateway without access to the public internet). The terms “unsecured path” and “public path” are used interchangeably to refer to sending packets using IP addresses for both source and destination that are public IP addresses (e.g., IP addresses accessible via the public internet), or to otherwise using routes that have connectivity outside of the managed network infrastructure (e.g., through a gateway with access to the public internet).

The on-demand code execution system can allow function invokers or function owners to opt-in to using only private paths for communications from an invoked function to an endpoint outside of the on-demand code execution system, such as to a managed storage or computing service operating within the same managed network infrastructure as the on-demand code execution system. During subsequent execution of a function owned by a function owner or invoked by a function invoker who has opted-in to using only private communication paths, the on-demand code execution system can ensure that traffic from the invoked function to the managed storage or computing service is routed through a private path. In one embodiment, an endpoint manager within the on-demand code execution system can intercept this traffic and utilize a Domain Name System (DNS) resolver to determine whether to route the traffic to a secure virtual private cloud (VPC) endpoint through which the traffic will be securely communicated to the destination endpoint, or to permit the traffic to take an unsecured path (e.g., via the public internet or otherwise using a public IP address). In another embodiment, the endpoint manager can configure computing components of the on-demand code execution system (e.g., virtual machines that will execute the function owner's or function invoker's function) such that a mapping of the managed storage or computing service to an IP address of a private endpoint is injected into the computing components prior to (or concurrently with) function invocation.

### Introduction

Some data centers may include a number of interconnected computing systems to provide computing resources to users of the data center. To facilitate increased utilization of data center resources, virtualization technologies allow a single physical computing device to host one or more instances of virtual machines that appear and operate as independent computing devices to users of a data center. With virtualization, the single physical computing device can create, maintain, delete, or otherwise manage virtual machines in a dynamic manner. In turn, users can request compute resources from such a data center, including single computing devices or a configuration of net worked computing devices, and be provided with varying numbers of virtual machine resources.

Some data centers include an on-demand code execution system, sometimes referred to as a serverless function execution system. Generally described, on-demand code execution systems enable execution of arbitrary user-designated function code, without requiring the user to create, maintain, or configure an execution environment (e.g., a physical or virtual machine) in which the function code is executed. For example, whereas conventional computing services often require a user to provision a specific device (virtual or physical), install an operating system on the device, configure application settings, define network interfaces, and so on, an on-demand code execution system may enable a user to submit code and may provide to the user an application programming interface (API) that, when used, enables the user to request execution of the function code. Upon receiving a call through the API, the on-demand code execution system may dynamically generate an execution environment for the code, provision the environment with the code, execute the code, and provide a result. Thus, an on-demand code execution system can remove a need for a user to handle configuration and management of environments for code execution. Due to the flexibility of on-demand code execution system to execute arbitrary function code, such a system can be used to create a variety of network services. For example, such a system could be used to create a “micro-service,” a network service that implements a small number of functions (or only one function), and that interacts with other services to provide an application. In the context of on-demand code execution systems, the instance of function code executing to provide such a service is often referred to as an “invoked function,” or simply as an “invoke” or “function” for brevity.

Function invokers can invoke functions on the on-demand code execution system (e.g., through different computing devices, etc.). When the function invokers invoke functions on the on-demand code execution system, the on-demand code execution system may execute these functions to completion and, in some cases, provide the function invoker results of the execution. As the on-demand code execution system executes code associated with a function, various communications may be initiated to endpoints outside of the on-demand code execution system. For example, a function may access or store data on a network-based data storage service, request execution of an application hosted on a network-based compute service, or the like. Such services are referred to herein as “network-based” to contrast them from local storage and compute resources available on a local device or otherwise within the on-demand code execution system on which a function is executing. In some cases, even if the network-based services are hosted on the same managed network infrastructure as the on-demand code execution system, the network-based services may be publicly-accessible (e.g., may have network addresses accessible via the public internet). As a result, traffic (e.g., network packets) associated with the executed code may travel paths accessible outside the managed network infrastructure (e.g., through gateways with access to the public internet) even if the traffic is being communicated to network-based services or other destinations that are also within the same managed network infrastructure. In some cases, the on-demand code execution system may route the traffic through a path including the public internet, where information associated with the traffic (e.g., packets) may be vulnerable to interception and/or pose other security related concerns (e.g., traffic unintentionally broadcast to parties who are not authorized).

Some aspects of the present disclosure address some or all of the issues noted above, among others, by providing an improved on-demand code execution system and an endpoint manager configured to selectively use private paths and isolate traffic from the public internet. The endpoint manager can assist in routing traffic of the on-demand code execution system (e.g., after/before/during a function invocation by a function invoker) over a managed infrastructure path that extends from the on-demand code execution system to the destination address. In some embodiments, a private endpoint such as a VPC endpoint can be attached to a VPC in which the on-demand code execution system is implemented. The VPC endpoint may be configured to communicate only with other endpoints within the managed infrastructure (e.g., the VPC endpoint may not have access to direct packets out over—or to receive packets from—the public internet). For example, the VPC endpoint may only have access to routing data for components within the managed infrastructure via a private IP address (e.g., not visible to the public internet). Thus, outgoing traffic from an invoked function can be routed via the VPC endpoint in order to provide a level of assurance that information associated with the traffic will not be sent to or from a public IP address.

In some cases, function invokers may prefer that only certain function-initiated traffic be routed to a VPC endpoint while allowing other traffic to be sent using public IP addresses (e.g., based on how sensitive the information is, among other factors). Therefore, the endpoint manager can offer function invokers the ability to either opt-in or opt-out of having their function-initiated traffic be sent through a VPC endpoint on a destination-service-specific basis, rather than requiring all function-initiated traffic being sent through a VPC endpoint.

After a function invoker or function owner opts into enforcement of private communication paths (e.g., non-public communication paths, such as paths not including public IP addresses) for traffic originating from their functions, the managed VPC can automatically route function-initiated traffic associated with the opt-in to the VPC endpoint and avoid at least the issues posed with routing traffic using public IP addresses. Moreover, function invokers are relieved of the tasks of managing their own private path (e.g., setting up and maintaining their own VPC with a VPC endpoint) since the on-demand code execution system managed VPC can securely route their function-initiated traffic automatically over a private path after opting in.

In some embodiments herein, a VPC represents a logically-isolated pool of computing resources within a physical cloud provider managed network infrastructure. In some embodiments, different VPCs may be associated with different accounts of the cloud provider network, providing additional separation and distinction between VPCs.

In one embodiment, an on-demand code execution system can be implemented within a VPC of the cloud provider network. The VPC may include an endpoint manager configured to implement aspects of the present disclosure. The endpoint manager can intercept function-initiated traffic and direct such traffic to over a private path. For example, a function invoker may opt-in to having its traffic being routed over private paths for certain functions and the managed VPC may utilize a DNS resolver configured to ensure that the DNS resolution traffic associated with those functions is assigned a private IP address such that the traffic is routed through the VPC endpoint (e.g., not visible to the public internet). In this example, when the function invoker invokes a function (e.g., for which the function invoker opted in to use of the VPC endpoint) via the on-demand code execution system, the DNS resolver can return the IP address of the VPC endpoint for DNS requests associated with all outgoing traffic from the opted-in function. This has the effect of redirecting the traffic to the VPC endpoint. Because the VPC endpoint does not have access to the public internet, this ensures a private communication path to a destination endpoint.

In another embodiment, the endpoint manager can inject data into a local DNS server or DNS cache on a virtual machine associated with an invoked function to ensure that traffic associated with that invoked function is sent over a private path. For example, a function invoker may opt-in to having its traffic being routed to a VPC endpoint for certain functions and the managed VPC may utilize a micro virtual machine (VM) manager to inject DNS entries (e.g., via “dnsmasq”) into the VMs for those functions. The DNS entries may map network-accessible services to the private IP address of the VPC endpoint, rather than to a publicly-accessible IP address that is reachable via the public internet. In this example, when the function invoker invokes a function via the on-demand code execution system, the VM associated with the opted-in function can be provisioned with one or more DNS records configured to ensure any traffic associated with that function is routed to a VPC endpoint for a private path (e.g., private IP address not visible to the public internet). The DNS records may map network-accessible services to the IP address of the VPC endpoint, rather than to a publicly-accessible IP address that is reachable via the public internet.

Advantageously, via at least the embodiments descried herein, a function invoker can receive the benefits of a private communication path between different cloud services through use of an endpoint manager. Moreover, since the managed VPC which comprises the endpoint manager can maintain all the configurations (e.g., whether a function invoker or function owner opted in) and the technical infrastructure (e.g., network connections, computing systems, software, VPCs, VPC endpoints, etc.) that allows routing of function-initiated traffic through a private path, a function invoker or function owner is not burdened with maintaining such configurations and technical infrastructure itself.

Various aspects of the disclosure will be described with regard to certain examples and embodiments, which are intended to illustrate but not limit the disclosure. Although aspects of some embodiments described in the disclosure will focus, for the purpose of illustration, on particular examples of on-demand functions, DNS resolvers, local DNS servers and caches, VPC endpoints, and on-demand code execution system configurations, the examples are illustrative only and are not intended to be limiting. In some embodiments, the techniques described herein may be applied to additional or alternative types of on-demand functions, DNS resolvers, local DNS servers and caches, VPC endpoints, and on-demand code execution system configurations. Additionally, any feature used in any embodiment described herein may be used in any combination with any other feature or in any other embodiment, without limitation.

### Example Network Environment

An on-demand code execution system may provide a network-accessible service enabling users to submit or designate computer-executable source code—also referred to herein as “function code,” or simply as “code” for brevity—to be executed by virtual machine instances on the on-demand code execution system. Each set of function code on the on-demand code execution system may define a “task,” and implement specific functionality corresponding to that task when executed on a virtual machine instance of the on-demand code execution system. Individual implementations of the task on the on-demand code execution system may be referred to as an “execution” of the task (or a “task execution”). In some cases, the on-demand code execution system may enable users to directly trigger execution of a task based on a variety of potential events, such as transmission of an API or specially formatted hypertext transport protocol (“HTTP”) packet to the on-demand code execution system. The on-demand code execution system can therefore execute any specified executable code “on-demand,” without requiring configuration or maintenance of the underlying hardware or infrastructure on which the code is executed. Further, the on-demand code execution system may be configured to execute tasks in a rapid manner (e.g., in under 100 milliseconds [ms]), thus enabling execution of tasks in “real-time” (e.g., with little or no perceptible delay to an end user). To enable this rapid execution, the on-demand code execution system can include one or more virtual machine instances that are “pre-warmed” or pre initialized (e.g., booted into an operating system and executing a complete or substantially complete runtime environment) and configured to enable execution of user-defined code, such that the code may be rapidly executed in response to a request to execute the code, without delay caused by initializing the virtual machine instance. Thus, when an execution of a task is triggered, the code corresponding to that task can be executed within a pre-initialized virtual machine in a very short amount of time.

Specifically, to execute tasks, the on-demand code execution system described herein may maintain a pool of executing virtual execution environments (e.g., virtual machine instances and/or containers) that are ready for use as soon as a request to execute a task is received. Due to the pre initialized nature of these virtual execution environments, delay (sometimes referred to as latency) associated with executing the task code (e.g., instance and language runtime startup time) can be significantly reduced, often to sub 100 millisecond levels. Illustratively, the on-demand code execution system may maintain a pool of virtual execution environments on one or more physical computing devices, where each virtual machine instance has one or more software components (e.g., operating systems, language runtimes, libraries, etc.) loaded thereon. When the on-demand code execution system receives a request to execute program code (a “task”), the on-demand code execution system may select a virtual execution environment for executing the program code of the user based on the one or more computing constraints related to the task (e.g., a required operating system or runtime) and cause the task to be executed on the selected virtual machine instance. The tasks can be executed in isolated containers that are created on the virtual machine instances, or may be executed within a virtual machine instance isolated from other virtual machine instances acting as environments for other tasks. Since the virtual machine instances in the pool have already been booted and loaded with particular operating systems and language runtimes by the time the requests are received, the delay associated with finding compute capacity that can handle the requests (e.g., by executing the user code in one or more containers created on the virtual machine instances) can be significantly reduced.

As used herein, the term “virtual machine instance” is intended to refer to an execution of software or other executable code that emulates hardware to provide an environment or platform on which software may execute (an example “execution environment”). Virtual machine instances are generally executed by hardware devices, which may differ from the physical hardware emulated by the virtual machine instance. For example, a virtual machine may emulate a first type of processor and memory while being executed on a second type of processor and memory. Thus, virtual machines can be utilized to execute software intended for a first execution environment (e.g., a first operating system) on a physical device that is executing a second execution environment (e.g., a second operating system). In some instances, hardware emulated by a virtual machine instance may be the same or similar to hardware of an underlying device. For example, a device with a first type of processor may implement a plurality of virtual machine instances, each emulating an instance of that first type of processor. Thus, virtual machine instances can be used to divide a device into a number of logical sub-devices (each referred to as a “virtual machine instance”). While virtual machine instances can generally provide a level of abstraction away from the hardware of an underlying physical device, this abstraction is not required. For example, assume a device implements a plurality of virtual machine instances, each of which emulate hardware identical to that provided by the device. Under such a scenario, each virtual machine instance may allow a software application to execute code on the underlying hardware without translation, while maintaining a logical separation between software applications running on other virtual machine instances. This process, which is generally referred to as “native execution,” may be utilized to increase the speed or performance of virtual machine instances. Other techniques that allow direct utilization of underlying hardware, such as hardware pass-through techniques, may be used, as well.

While a virtual machine executing an operating system is described herein as one example of an execution environment, other execution environments (e.g., other virtual execution environments or physical environments) are also possible. For example, tasks or other processes may be executed within a software “container,” which provides a runtime environment without itself providing virtualization of hardware. Containers may be implemented within virtual machines to provide additional security, or may be run outside of a virtual machine instance.

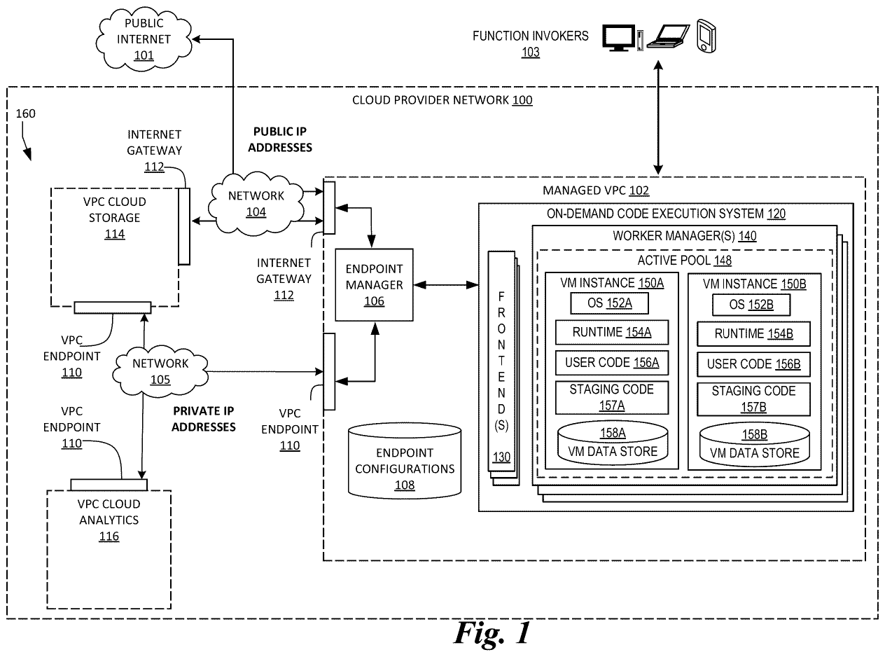

FIG. 1 is a block diagram of a cloud provider network 100 in which a managed VPC 102 operates an endpoint manager 106. The endpoint manager 106 enables function-initiated traffic (e.g., via an on-demand code execution system 120) to be routed through a private path to network-based services 160 (e.g., VPC cloud storage 114 and/or VPC cloud analytics 116).

By way of illustration, function invokers 103 are shown in communication with the managed VPC 102, including a desktop computer, laptop, and a mobile phone. In general, the function invokers 103 can be any computing device such as a desktop, laptop or tablet computer, personal computer, wearable computer, server, personal digital assistant (PDA), hybrid PDA/mobile phone, mobile phone, electronic book reader, set top box, voice command device, camera, digital media player, and the like.

Generally described, network-based services 160 can operate to enable the function invokers 103 to gain access to cloud-based products (e.g., cloud compute instances, cloud storage, cloud databases, cloud networking and content delivery, cloud based artificial intelligence (AI) services, etc.). Network-based services 160 may also be referred to as “managed services” or “cloud services.” For example, the VPC cloud storage 114 can operate to enable clients (e.g., the function invokers 103) to remotely read, write, modify, and delete data, such as files, objects, blocks, or records, each of which represents a set of data associated with an identifier (an “object identifier” or “resource identifier”) that can be interacted with as an individual resource. An object may represent a single file submitted by a client device (though the VPC cloud storage 114 may or may not store such an object as a single file). This object-level interaction can be contrasted with other types of storage services, such as block-based storage in which data is manipulated at the level of individual blocks or database storage in which data manipulation may occur at the level of tables or the like. As another example, the VPC cloud analytics 116 can operate to enable clients to remotely access analytics services (e.g., big data analytics, log analytics, streaming analytics, etc.). As such, the VPC cloud analytics 116 may allow clients the ability to extract insights from different types of data.

The function invokers 103, VPC cloud storage 114, VPC cloud analytics 116, and on-demand code execution system 120 may communicate via one or more communication networks, which may include any wired network, wireless network, or combination thereof. For example, networks 104 or 105 (also described collectively as “the networks”) may be a personal area network, local area network, wide area network, satellite network, or combination thereof. In some embodiments, the networks may be a private or semi-private network, such as a corporate or university intranet. The networks can use protocols and components for communicating, such as Hypertext Transfer Protocol (HTTP), HTTP Secure (HTTPS), Message Queue Telemetry Transport (MQTT), Constrained Application Protocol (CoAP), and the like. Protocols and components for communicating via communication networks are well known to those skilled in the art and, thus, are not described in more detail herein.

In some embodiments, as shown, a network such as network 104 may be in communication with or otherwise have access to a network outside of the cloud provider network 100 managed network infrastructure. For example, network 104 may have access to a publicly-accessible network of linked networks, possibly operated by various distinct parties, such as the public internet 101. To send traffic over and receive traffic via the public internet 101, a public IP address is used. Thus, the public internet 101 is not directly accessible via network 105, because network 105 is only in communication with VPC endpoints 110 within the cloud provider network 100 managed network infrastructure, rather than internet gateways 112 that are in communication with the public internet as described in greater detail below.

The on-demand code execution system 120 may be connected to the VPC cloud storage 114 or the VPC cloud analytics 116 via either by the network 104 or the network 105. As shown in FIG. 1, the on-demand code execution system 120 may connect to the VPC cloud storage 114 via the network 104 which uses a public IP address. Also shown is that the on-demand code execution system 120 may connect to both the VPC cloud storage 114 and the VPC cloud analytics 116 via the network 105 which provides a private path (e.g., entirely within the cloud provider network 100) such that any communications between these systems are transacted privately (e.g., the packets do not use public IP addresses).

The on-demand code execution system 120—also referred to as an on-demand code execution service—includes one or more frontends 130 which enable interaction with the on-demand code execution system 120. In an illustrative embodiment, the frontends 130 serve as a “front door” to the other services provided by the on-demand code execution system 120, enabling function invokers 103 to provide, request execution of, and view results of computer executable code. The frontends 130 include a variety of components to enable interaction between the on-demand code execution system 120 and other computing devices. For example, each frontend 130 may include a request interface providing function invokers 103 with the ability to upload or otherwise communicate user-specified code to the on-demand code execution system 120 and to thereafter request execution of that code. In one embodiment, the request interface communicates with external computing devices (e.g., function invokers 103, frontend 130, etc.) via a graphical user interface (GUI), CLI, or API. The frontends 130 process the requests and make sure that the requests are properly authorized. For example, the frontends 130 may determine whether the user associated with the request is authorized to access the user code specified in the request.

References to user code as used herein may refer to any program code (e.g., a program, routine, subroutine, thread, etc.) written in a specific program language. In the present disclosure, the terms “code,” “user code,” “function code,” and “program code,” may be used interchangeably. Such user code may be executed to achieve a specific function, for example, in connection with a particular data transformation developed by the user. As noted above, individual collections of user code (e.g., to achieve a specific function) are referred to herein as “tasks,” while specific executions of that code (including, e.g., compiling code, interpreting code, or otherwise making the code executable) are referred to as “task executions” or simply “executions.” Tasks may be written, by way of non-limiting example, in JavaScript (e.g., node.js), Java, Python, or Ruby (or another programming language).

To manage requests for code execution, the frontend 130 can include an execution queue, which can maintain a record of requested task executions. Illustratively, the number of simultaneous task executions by the on-demand code execution system 120 is limited, and as such, new task executions initiated at the on-demand code execution system 120 (e.g., via an API call, via a call from an executed or executing task, etc.) may be placed on the execution queue and processed, e.g., in a first-in-first-out order. In some embodiments, the on-demand code execution system 120 may include multiple execution queues, such as individual execution queues for each user account. For example, users of the cloud provider network 100 may desire to limit the rate of task executions on the on-demand code execution system 120 (e.g., for cost reasons). Thus, the on-demand code execution system 120 may utilize an account-specific execution queue to throttle the rate of simultaneous task executions by a specific user account. In some instances, the on-demand code execution system 120 may prioritize task executions, such that task executions of specific accounts or of specified priorities bypass or are prioritized within the execution queue. In other instances, the on-demand code execution system 120 may execute tasks immediately or substantially immediately after receiving a call for that task, and thus, the execution queue may be omitted.

The frontend 130 can further include an output interface configured to output information regarding the execution of tasks on the on-demand code execution system 120. Illustratively, the output interface may transmit data regarding task executions (e.g., results of a task, errors related to the task execution, or details of the task execution, such as total time required to complete the execution, total data processed via the execution, etc.) to the function invokers 103.

In some embodiments, the on-demand code execution system 120 may include multiple frontends 130. In such embodiments, a load balancer may be provided to distribute the incoming calls to the multiple frontends 130, for example, in a round-robin fashion. In some embodiments, the manner in which the load balancer distributes incoming calls to the multiple frontends 130 may be based on the location or state of other components of the on-demand code execution system 120. For example, a load balancer may distribute calls to a geographically nearby frontend 130, or to a frontend with capacity to service the call. In instances where each frontend 130 corresponds to an individual instance of another component of the on-demand code execution system 120, such as the active pool 148 described below, the load balancer may distribute calls according to the capacities or loads on those other components. Calls may in some instances be distributed between frontends 130 deterministically, such that a given call to execute a task will always (or almost always) be routed to the same frontend 130. This may, for example, assist in maintaining an accurate execution record for a task, to ensure that the task executes only a desired number of times. For example, calls may be distributed to load balance between frontends 130. Other distribution techniques, such as anycast routing, will be apparent to those of skill in the art.

The on-demand code execution system 120 further includes one or more worker managers 140 that manage the execution environments, such as virtual machine instances 150 (shown as VM instance 150A and 150B, generally referred to as a “VM”), used for servicing incoming calls to execute tasks. While the following will be described with reference to virtual machine instances 150 as examples of such environments, embodiments of the present disclosure may utilize other environments, such as software containers. In the example illustrated in FIG. 1, each worker manager 140 manages an active pool 148, which is a group (sometimes referred to as a pool) of virtual machine instances 150 executing on one or more physical host computing devices that are initialized to execute a given task (e.g., by having the code of the task and any dependency data objects loaded into the instance).

Although the virtual machine instances 150 are described here as being assigned to a particular task, in some embodiments, the instances may be assigned to a group of tasks, such that the instance is tied to the group of tasks and any tasks of the group can be executed within the instance. For example, the tasks in the same group may belong to the same security group (e.g., based on their security credentials) such that executing one task in a container on a particular instance 150 after another task has been executed in another container on the same instance does not pose security risks. A task may be associated with permissions encompassing a variety of aspects controlling how a task may execute. For example, permissions of a task may define what network connections (if any) can be initiated by an execution environment of the task. As another example, permissions of a task may define what authentication information is passed to a task, controlling what network-accessible resources are accessible to execution of a task (e.g., network-based services 160). In one embodiment, a security group of a task is based on one or more such permissions. For example, a security group may be defined based on a combination of permissions to initiate network connections and permissions to access network resources. As another example, the tasks of the group may share common dependencies, such that an environment used to execute one task of the group can be rapidly modified to support execution of another task within the group.

Once a triggering event to execute a task has been successfully processed by a frontend 130, the frontend 130 passes a request to a worker manager 140 to execute the task. In one embodiment, each frontend 130 may be associated with a corresponding worker manager 140 (e.g., a worker manager 140 co-located or geographically nearby to the frontend 130) and thus, the frontend 130 may pass most or all requests to that worker manager 140. In another embodiment, a frontend 130 may include a location selector configured to determine a worker manager 140 to which to pass the execution request. In one embodiment, the location selector may determine the worker manager 140 to receive a call based on hashing the call, and distributing the call to a worker manager 140 selected based on the hashed value (e.g., via a hash ring). Various other mechanisms for distributing calls between worker managers 140 will be apparent to one of skill in the art.

Thereafter, the worker manager 140 may modify a virtual machine instance 150 (if necessary) and execute the code of the task within the instance 150. As shown in FIG. 1, respective instances 150 may have operating systems (OS) 152 (shown as OS 152A and 152B), language runtimes 154 (shown as runtime 154A and 154B), and user code 156 (shown as user code 156A and 156B). The OS 152, runtime 154, and user code 156 may collectively enable execution of the user code to implement the task. Thus, via operation of the on-demand code execution system 120, tasks may be rapidly executed within an execution environment.

In accordance with aspects of the present disclosure, each VM 150 additionally includes staging code 157 executable to facilitate staging of input data on the VM 150 and handling of output data written on the VM 150, as well as a VM data store 158 accessible through a local file system of the VM 150. Illustratively, the staging code 157 represents a process executing on the VM 150 (or potentially a host device of the VM 150) and configured to obtain data from the network-based services 160 and place that data into the VM data store 158. The staging code 157 can further be configured to obtain data written to a file within the VM data store 158, and to transmit that data to the network-based services 160. Because such data is available at the VM data store 158, user code 156 is not required to obtain data over a network, simplifying user code 156 and enabling further restriction of network communications by the user code 156, thus increasing security. Rather, as discussed above, user code 156 may interact with input data and output data as files on the VM data store 158, by use of file handles passed to the code 156 during an execution. In some embodiments, input and output data may be stored as files within a kernel-space file system of the data store 158. In other instances, the staging code 157 may provide a virtual file system, such as a filesystem in userspace (FUSE) interface, which provides an isolated file system accessible to the user code 156, such that the user code's access to the VM data store 158 is restricted.

As used herein, the term “local file system” generally refers to a file system as maintained within an execution environment, such that software executing within the environment can access data as a file, rather than via a network connection. In accordance with aspects of the present disclosure, the data storage accessible via a local file system may itself be local (e.g., local physical storage), or may be remote (e.g., accessed via a network protocol, like NFS, or represented as a virtualized block device provided by a network-accessible service). Thus, the term “local file system” is intended to describe a mechanism for software to access data, rather than physical location of the data.

The VM data store 158 can include any persistent or non-persistent data storage device. In one embodiment, the VM data store 158 is physical storage of the host device, or a virtual disk drive hosted on physical storage of the host device. In another embodiment, the VM data store 158 is represented as local storage, but is in fact a virtualized storage device provided by a network accessible service. For example, the VM data store 158 may be a virtualized disk drive provided by a network-accessible block storage service. In some embodiments, the network-based services 160 may be configured to provide file-level access to objects stored on the data stores 158, thus enabling the VM data store 158 to be virtualized based on communications between the staging code 157 and the network-based service 160. For example, the network-based services 160 can include a file-level interface providing network access to objects within the data stores 158 as files. The file-level interface may, for example, represent a network-based file system server (e.g., a network file system (NFS)) providing access to objects as files, and the staging code 157 may implement a client of that server, thus providing file-level access to objects of the network-based service 160.

In some instances, the VM data store 158 may represent virtualized access to another data store executing on the same host device of a VM instance 150. For example, an active pool 148 may include one or more data staging VM instances (not shown in FIG. 1), which may be co-tenanted with VM instances 150 on the same host device. A data staging VM instance may be configured to support retrieval and storage of data from the network-based service 160 (e.g., data objects or portions thereof, input data passed by function invokers 103, etc.), and storage of that data on a data store of the data staging VM instance. The data staging VM instance may, for example, be designated as unavailable to support execution of user code 156, and thus be associated with elevated permissions relative to instances 150 supporting execution of user code. The data staging VM instance may make this data accessible to other VM instances 150 within its host device (or, potentially, on nearby host devices), such as by use of a network-based file protocol, like NFS. Other VM instances 150 may then act as clients to the data staging VM instance, enabling creation of virtualized VM data stores 158 that, from the point of view of user code 156A, appear as local data stores. Beneficially, network-based access to data stored at a data staging VM can be expected to occur very quickly, given the co-location of a data staging VM and a VM instance 150 within a host device or on nearby host devices.

While some examples are provided herein with respect to use of IO stream handles to read from or write to a VM data store 158, IO streams may additionally be used to read from or write to other interfaces of a VM instance 150 (while still removing a need for user code 156 to conduct operations other than stream-level operations, such as creating network connections). For example, staging code 157 may “pipe” input data to an execution of user code 156 as an input stream, the output of which may be “piped” to the staging code 157 as an output stream. As another example, a staging VM instance or a hypervisor to a VM instance 150 may pass input data to a network port of the VM instance 150, which may be read-from by staging code 157 and passed as an input stream to the user code 157. Similarly, data written to an output stream by the task code 156 may be written to a second network port of the instance 150A for retrieval by the staging VM instance or hypervisor. In yet another example, a hypervisor to the instance 150 may pass input data as data written to a virtualized hardware input device (e.g., a keyboard) and staging code 157 may pass to the user code 156 a handle to the IO stream corresponding to that input device. The hypervisor may similarly pass to the user code 156 a handle for an IO stream corresponding to a virtualized hardware output device, and read data written to that stream as output data. Thus, the examples provided herein with respect to file streams may generally be modified to relate to any IO stream.

The network-based services 160 and on-demand code execution system 120 are depicted in FIG. 1 as operating in a distributed computing environment including several computer systems that are interconnected using one or more computer networks (e.g., network 105). The network-based services 160 and on-demand code execution system 120 could also operate within a computing environment having a fewer or greater number of devices than are illustrated in FIG. 1. Thus, the depiction of the network-based services 160 and on-demand code execution system 120 in FIG. 1 should be taken as illustrative and not limiting to the present disclosure.

The endpoint manager 106 can either intercept DNS requests associated with a function or inject DNS entries (e.g., via a dnsmasq) into a local DNS server or DNS cache on a VM associated with the function to provide a private path for the traffic when the traffic travels to cloud services such as VPC cloud storage 114 and VPC cloud analytics 116 (e.g., or other network-based services 160 such as AI services, etc.). As shown in FIG. 1, the endpoint manager 106 can help determine whether the traffic should be routed to a VPC endpoint 110 (e.g., a type of private path) or whether the traffic should be routed to an internet gateway 112 (e.g., using a public IP address).

In one embodiment, the endpoint manager 106 may intercept the traffic associated with the function by using a DNS resolver. If using a DNS resolver, the endpoint manager 106 may evaluate DNS requests associated with the function (e.g., from a VM associated with the function) to see if a function invoker 103, who invoked the function, opted into routing function-initiated traffic through a private path (e.g., VPC endpoint 110 using a private IP address not visible to the public internet). If the function invoker 103 opted in, the DNS resolver may return (e.g., as a response to a DNS request and to a VM associated with the function) a private IP address of the VPC endpoint 110. Thus, when the VM associated with the function sends traffic to network-based services 160 (e.g., the VPC cloud storage 114, etc.), it can send such traffic using the private IP address of the VPC endpoint 110. If the function invoker 103 did not opt-in, the DNS resolver may return (e.g., as a response to a DNS request and to a VM associated with the function) a public IP address of the internet gateway 112. Thus, when the VM associated with the function sends traffic to network-based services 160 (e.g., the VPC cloud analytics 116, etc.), it can send such traffic using the public IP address of the internet gateway 112.

In some embodiments, the endpoint manager 106 may utilize a micro VM manager to inject data into a local DNS server or DNS cache on a VM associated with an invoked function. For example, the endpoint manager 106 may utilize the micro VM manager to inject DNS entries (e.g., DNS entries mapping a network-based service to an IP address) into a component running on (e.g., dnsmasq), or associated with, a VM instance and/or container that was created and/or assigned to the invoked function. As a result, any traffic leaving from the VM instance and/or container to a network-based service is sent to the assigned IP address. If the function invoker 103 opted into routing function-initiated traffic through a private path (e.g., VPC endpoint 110), the micro VM manager may inject DNS entries (e.g., with the IP address of the VPC endpoint 110) to a component of the VM instance and/or container to route traffic to a private path. Additionally, if the function invoker 103 did not opt-in, the micro VM manager may inject DNS entries (e.g., with the public IP address of the internet gateway 112) to a component of the VM instance and/or container to route traffic to an unsecure path (e.g., using a public IP address). Therefore, based on whether the function invoker 103 opted in or opted out, when the VM instance and/or container has traffic destined for network-based services, DNS entries may be injected into a component (e.g., dnsmasq) of the VM instance and/or container to set an IP address of where the traffic should be routed to automatically (e.g., to the VPC endpoint 110 (opted in) or to the internet gateway 112 (opted out)).

As shown in FIG. 1, the VPC endpoint 110 and the internet gateway 112 provide can provide either a private path, or routing of function-initiated traffic through an unsecure public IP address, respectively. If the traffic of the invoked function is routed to the internet gateway 112 (e.g., via a public IP address of the internet gateway 112), the traffic of the invoked function may pass through the network 104 but using a public IP address of a cloud service (e.g., the VPC cloud storage 114). If the traffic of the invoked function is routed to the VPC endpoint 110, the traffic of the invoked function may pass through the network 105 via a private path (e.g., using a private IP address while entirely within the cloud provider network 100 without reaching the public internet, possibly using SSL, Transport Layer Security (TLS), or HTTPS, etc. for connection security) to a cloud service (e.g., the VPC cloud storage 114 and/or VPC cloud analytics 116). As such, using the VPC endpoint 110, the traffic may be more protected from security issues that would otherwise arise when using the internet gateway 112. Moreover, the endpoint manager 106 also can include an endpoint configurations data store 108 that can store whether a function invoker 103 opted in or opted out regarding a private path.

### Routing of Traffic by a DNS Resolver or by Injecting DNS Entries

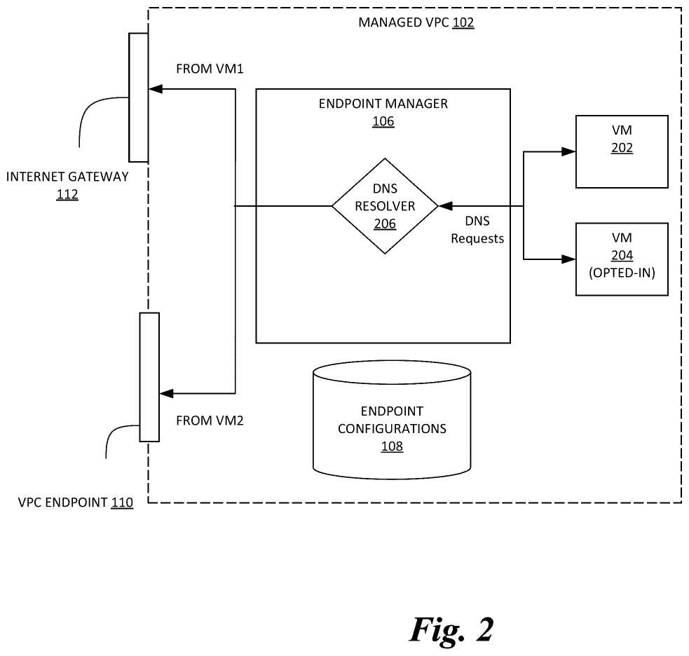

FIG. 2 is a block diagram of a managed VPC 102 where traffic from function invocations via the on-demand code execution system 120 can be routed securely to cloud services by a DNS resolver 206. In some embodiments, as shown, the managed VPC 102 includes an endpoint manager 106, a DNS resolver 206, and endpoint configurations data store 108. Described in more detail below, the DNS resolver 206 can intercept DNS requests of VMs associated with function invokers 103. After intercepting the DNS requests, the DNS resolver 206 can check to see if the function invokers 103 opted in concerning a private path and then return a DNS response with associated IP addresses (e.g., of either a private path or unsecure path), based on whether a function invoker 103 opted in.

As shown in FIG. 2, VM 202 and VM 204 make DNS requests to the endpoint manager 106 which can be intercepted by the DNS resolver 206. After receiving the DNS requests, the DNS resolver 206 may check to see which function invoker 103 made the DNS request via their VM. Once determining the function invoker 103, the DNS resolver 206 may then reference the endpoint configurations data store 108 to determine whether the function invoker 103 opted for a private path. For example, the DNS resolver may reference the endpoint configurations data store 108 and determine that a first function invoker 103 associated with VM 202 opted out of (or did not opt into) using a private path and a second function invoker 103 associated with VM 204 opted in to (or did not opt out of) using a private path, for communicating with cloud services (e.g., VPC cloud storage 114 and VPC cloud analytics 116, etc.) concerning their function-initiated traffic. A described herein, the opt-in and the opt-out settings of the first function invoker and the second function invoker, respectively, can be stored in the endpoint configurations data store 108 such that the endpoint manager 106 may retrieve these settings when needed.

The DNS resolver 206 may then respond and/or reply to the DNS request (e.g., by the VM) with DNS entries which may have the IP address of the endpoint to which the VM may route function-initiated traffic. For example, due to the first function invoker 103 opting out of having a private path in this example, when the VM associated with the first function invoker 103 makes a DNS request, the DNS request will be intercepted by the DNS resolver 206 within the endpoint manager 106. The DNS resolver may then determine that the first function invoker 103 opted out of a private path and then send a response (e.g., to the VM) with DNS entries which may have the IP address of the unsecure path (e.g., the internet gateway 112). The VM may then associate the IP address of the unsecure path with traffic leaving the VM. As such, when the VM routes traffic of the first function invoker 103 to cloud services, such traffic may be routed to the internet gateway 112 using a public IP address, which in some cases may lead to transmission over the public internet.

Furthermore, due to the second function invoker 103 opting for a private path in this example, when the VM associated with the second function invoker 103 makes a DNS request, the DNS request will be intercepted by the DNS resolver 206 within the endpoint manager 106. The DNS resolver may then determine that the second function invoker 103 opted for a private path and then send a response (e.g., to the VM) with DNS entries which may have the IP address of the private path (e.g., the VPC endpoint 110). The VM may then associate the IP address of the private path with traffic leaving the VM. As such, when the VM routes traffic of the second function invoker 103 to cloud services, such traffic may be routed to the VPC endpoint 110 which may be a secure or private path (e.g., entirely within the cloud provider network 100 infrastructure via a private IP address not visible to the public internet, such as via network 105).

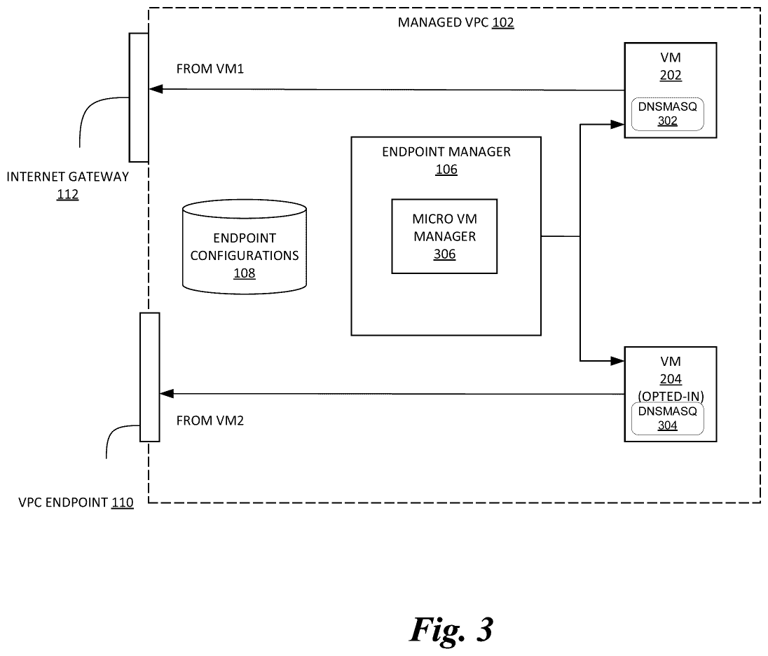

FIG. 3 is a block diagram of a managed VPC 102 where communications from functions invoked via the on-demand code execution system 120 can be routed securely to cloud services by use of a local DNS server according to some embodiments. In some embodiments, as shown, the managed VPC 102 includes an endpoint manager 106, a micro VM manager 306, and endpoint configurations data store 108.

As shown in FIG. 3, the endpoint manager 106 can use a micro VM manager 306 to inject DNS entries (e.g., with associated IP addresses for routing traffic) into a local DNS server or DNS cache on VMs associated with function invokers 103 to ensure traffic associated with an invoked function is sent over a private path (e.g., via a private IP address so that the traffic remains entirely within the cloud provider network 100 infrastructure, such as via network 105). This injection of DNS entries may be performed during setup and/or creation of a VM for a function invoker 103 and may be based on whether the function invoker 103 opts for a private path when communicating with cloud services. The injection of DNS entries can result in traffic from the VM being routed to an IP address associated with the DNS entries. For example, a first function invoker 103 associated with VM 202 may have opted out of (or not opted into) a private path and a second function invoker 103 associated with VM 204 may have opted in to (or not opted out of) a private path, when communicating with cloud services (e.g., VPC cloud storage 114 and VPC cloud analytics 116) for their function-initiated traffic. The opt-out and the opt-in settings of the VM 202 and the VM 204, respectively, can be stored in the endpoint configurations data store 108 such that the endpoint manager 106 may retrieve these settings when needed.

As illustrated in FIG. 3, due to the first function invoker 103 associated with the VM 202 opting out of having a private path in this example (e.g., when the micro VM manager 306 references the endpoint configurations data store 108 to determine this), the endpoint manager 106 may utilize the micro VM manager 306 to inject DNS entries (e.g., with an IP address of the internet gateway 112, a public IP address) into a local DNS server of the VM 202. For example, the local DNS server may be a dnsmasq 302 running on the VM 202 where the dnsmasq may accept DNS entry injection to assist in routing traffic for the VM 202. This injection may occur when such VM was created and/or configured for the first function invoker 103 (where the DNS entries contain the IP address of the internet gateway 112 and that IP address is assigned to the dnsmasq of VM 202). Therefore, once the micro VM manager 306 injects the dnsmasq 302 with DNS entries, the traffic coming from VM 202 may be routed to the internet gateway 112. As such, when a function is invoked on the VM 202, the traffic associated with that VM may be routed (e.g., via the dnsmasq 302) to the IP address of the internet gateway 112 (e.g., a public IP address).

Moreover, due to the second function invoker 103 associated with the VM 204 opting for a private path in this example (e.g., when the micro VM manager 306 references the endpoint configurations data store 108 to determine this), the endpoint manager 106 may utilize the micro VM manager 306 to inject DNS entries (e.g., with a private IP address of the VPC endpoint 110) into a local DNS server of the VM 204. The local DNS server may be a dnsmasq 304 running on the VM 204 where the dnsmasq 304 may accept DNS entry injection to assist in routing traffic for the VM 204. This injection may occur when such VM was created and/or configured for the first function invoker 103 (where the DNS entries contain the IP address of the VPC endpoint 110 and that IP address is assigned to the dnsmasq of VM 204). Therefore, once the micro VM manager 306 injects the dnsmasq 304 with DNS entries, the traffic coming from VM 204 may be routed to the VPC endpoint 110. As such, when a function is invoked on the VM 204, the traffic associated with that VM may be routed (e.g., via the dnsmasq 304) to the IP address of the VPC endpoint 110 (e.g., a private path using SSL).

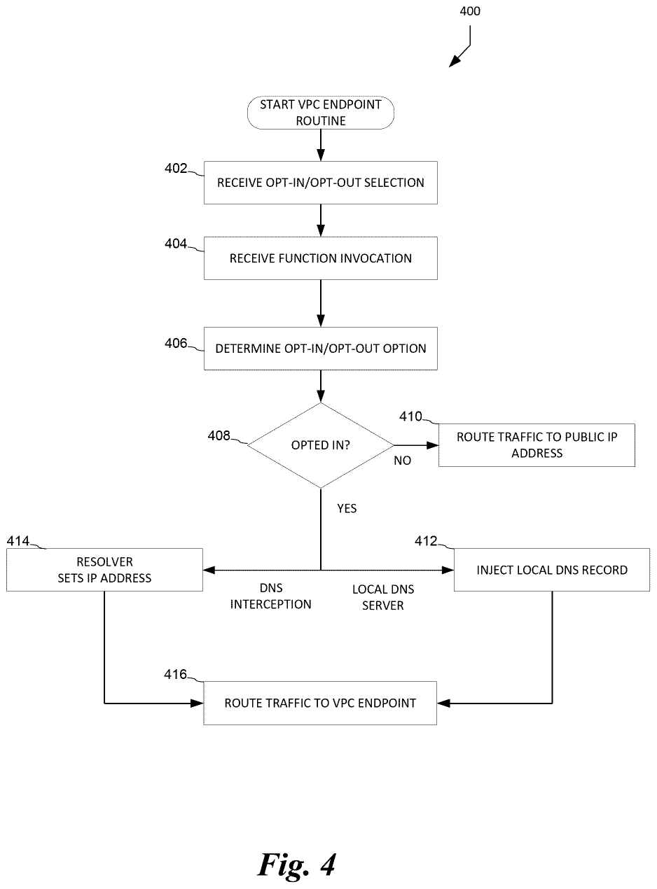

FIG. 4 is a flow diagram of an illustrative routine 400 for an on-demand code execution system 120 to determine whether to route traffic from an invoked function through a private path based on whether the function invoker or function owner has opted in to use of secure connections according to some embodiments.

The routine 400 begins at block 402. At block 402, the managed VPC 102 receives opt-in or opt-out information from function invokers 103. As stated herein, if a function invoker 103 opts in (or, in some embodiments, does not opt out), the managed VPC 102 may designate that any function-initiated traffic is routed to a private path (e.g., the VPC endpoint 110). On the other hand, if a function invoker 103 opts out (or, in some embodiments, does not opt in), the managed VPC 102 may designate that function-initiated traffic may be routed using a public IP address (e.g., through an internet gateway 112 with access to the public internet 101). The opt-in or opt-out information may be stored in the endpoint configurations data store 108. Moreover, as also described herein, the managed VPC 102 may utilize either a DNS resolver or a local DNS server (e.g., using a dnsmasq) to implement a private path for routing function-initiated traffic.

At block 404, the managed VPC 102 receives a function invocation from a function invoker 103. The function invocation can be associated with traffic that is destined for cloud services (e.g., the VPC cloud storage 114 and/or the VPC cloud analytics 116, AI cloud services, etc.) which requires traversal through one or more networks (e.g., the networks 104 and/or 105).

At block 406, the endpoint manager 106 of the managed VPC 102 may determine (e.g., via the endpoint configurations data store 108) whether the function invoker 103 opted in or opted out of a private path for its function-initiated traffic. It should be noted that in some instances (e.g., using a dnsmasq), a determination of whether the function invoker 103 opted in may be performed prior to any function-initiated traffic being generated (e.g., when a VM instance is created, configured, and/or generated), as is described in detail herein.

At decision 408, if the function invoker 103 opted out of having a private path, the managed VPC 102 may assign an IP address of a public IP address path through an internet gateway at block 410. As described herein, this may be accomplished by a local DNS server associated with a VM instance of the function-initiated or by use of a DNS resolver which may intercept DNS requests.

Still at decision 408, if the function invoker 103 opted in to having a private path, the managed VPC 102 may ensure a private IP address of a private path is assigned to function-initiated traffic.

At block 412, if the managed VPC 102 is implemented using a local DNS server, then the micro VM manager 306 may inject DNS entries of a private IP address associated with a private path into the VM, or a component of the VM (e.g., into a local DNS server, into DNS cache, or into a dnsmasq), of the function invoker 103.

At block 414, if the managed VPC 102 is implemented using a DNS resolver 206, then the DNS resolver 206 may be configured to intercept DNS requests associated with the function-initiated traffic and return a private IP address associated with a private path (e.g., the VPC endpoint 110) such that the sender (e.g., VM of the function invoker 103) may receive the IP address and assign it traffic leaving the VM of the function invoker 103.

At block 416, the managed VPC 102 routes the function-initiated traffic to a VPC endpoint which is a private path.

### Example Endpoint Manager System

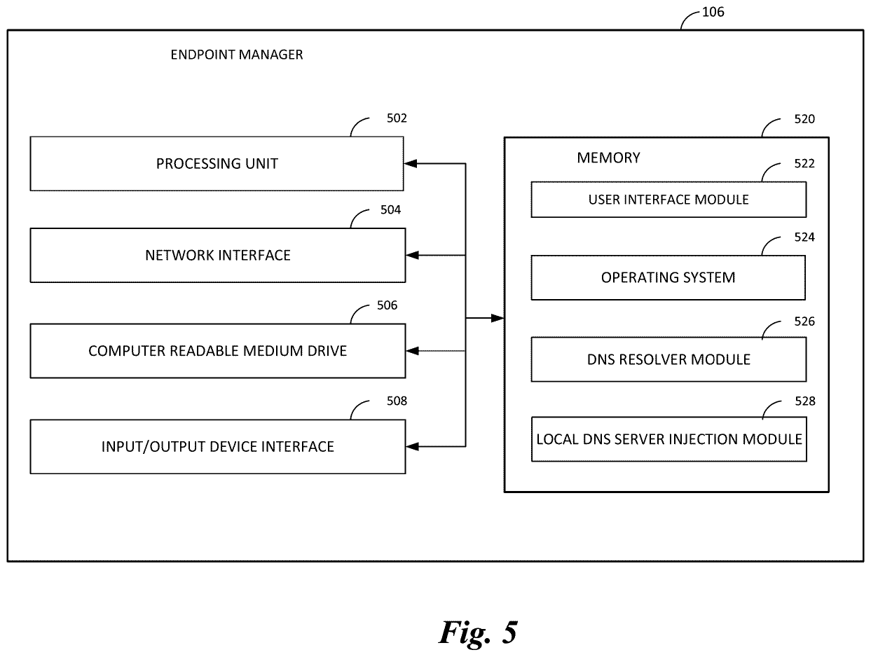

FIG. 5 illustrates various components of an example endpoint manager configured to implement various functionality described herein.

In some embodiments, as shown, an endpoint manager 106 may include: one or more computer processors 502, such as physical central processing units (CPUs); one or more network interfaces 504, such as a network interface cards (NICs); one or more computer readable medium drives 506; and one or more input and output device interfaces 508.

The primary memory 520 may include computer program instructions that one or more computer processors 502 execute and/or data that the one or more computer processors 502 use in order to implement one or more embodiments. For example, the primary memory 520 can store a user interface module 522 and an operating system 524 to provide general administration of the endpoint manager 106. As another example, the primary memory 520 can store DNS resolver module 526 for storing coding and configuration for defining a DNS resolver that determines whether traffic should be routed to a private path. As a further example, the primary memory 520 can store a local DNS server injection module 528 for defining procedure to inject DNS entries into virtual execution environments.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1-20. (canceled)

21. A system comprising:
a serverless function execution system hosted within a cloud provider network in communication with a public internet, wherein the serverless function execution system is configured to provide on-demand execution of function code; and
an endpoint manager configured to configure private connectivity to a plurality of network-based services via private network addresses not accessible via the public internet, wherein the endpoint manager comprises a set of one or more computing devices configured to:
receive a function invocation request to invoke a function configured to send one or more communications to a network-based service of the plurality of network-based services hosted within the cloud provider network and external to the serverless function execution system;
generate a mapping of the network-based service to a network address of a private endpoint associated with the serverless function execution system, wherein the private endpoint is configured to route network traffic within the cloud provider network using only one or more private network addresses of the cloud provider network, and wherein the public internet is not accessible via the private endpoint; and
cause execution of the function by a host computing device, wherein a network communication to the network-based service initiated by the function is sent to the private endpoint based on the mapping of the network-based service to the network address.

22. The system of claim 21, wherein the set of one or more computing devices is further configured to: receive a request to opt-in to use a private communication path within the cloud provider network for traffic initiated by a function.

23. The system of claim 22, wherein to receive the request, the set of one or more computing devices is further configured to receive the request from one of: a function owner of the function, or a function invoker of the function.

24. The system of claim 22, wherein the set of one or more computing devices is further configured to: store an opt-in record regarding the request in an endpoint configurations data store, wherein the opt-in record specifies the function and the network-based service to which communications initiated by the function are to be communicated over the private communication path.

25. The system of claim 22, wherein the set of one or more computing devices is further configured to: store an opt-in record regarding the request in an endpoint configurations data store, wherein the opt-in record specifies that all communications initiated by the function are to be communicated over the private communication path.

26. The system of claim 22, wherein the set of one or more computing devices is further configured to:
receive a second function invocation request to invoke a second function, wherein the second function invocation request is received from a same function invoker as the function invocation request, and wherein the request to opt-in applies to all network-based services with which functions invoked by the function invoker communicate;
provide, to a virtual execution environment configured to execute the second function, the mapping of the network-based service to the network address of the private endpoint; and
cause execution of the second function by the virtual execution environment, wherein a second network communication to the network-based service initiated by the second function is sent to the private endpoint based on the mapping of the network-based service to the network address.

27. The system of claim 21, wherein the set of one or more computing devices is further configured to:
receive a second function invocation request to invoke a second function, wherein the second function invocation request is received from a different function invoker than the function invocation request, and wherein no opt-in request associated with the second function has been received;
configure a virtual execution environment to execute the second function in response to the second function invocation request; and
cause execution of the second function by the virtual execution environment, wherein a second network communication to the network-based service initiated by the second function is sent using a public network address accessible via the public internet.

28. The system of claim 21, wherein to generate the mapping of the network-based service to the network address of the private endpoint, the set of one or more computing devices is further configured to provide a mapping record to a local domain name system (DNS) server in a virtual execution environment.

29. The system of claim 21, wherein the set of one or more computing devices is further configured to: route a second communication initiated by the function to a second network-based service through an internet gateway using a public network address accessible via the public internet.

30. A computer-implemented method comprising:
under control of an on-demand code execution system hosted within a cloud provider network in communication with a public internet, the on-demand code execution system comprising one or more computer processors configured to execute specific instructions:
receiving a function invocation request to invoke a function configured to send one or more communications to a network-based service hosted within the cloud provider network and external to the on-demand code execution system;
generating a mapping of the network-based service to a network address of a private endpoint associated with the on-demand code execution system, wherein the private endpoint is configured to route network traffic within the cloud provider network using only one or more private network addresses of the cloud provider network, and wherein the public internet is not accessible via the private endpoint; and
causing execution of the function by a host computing device, wherein a network communication to the network-based service initiated by the function is sent to the private endpoint based on the mapping of the network-based service to the network address.

31. The computer-implemented method of claim 30, further comprising receiving a request to opt-in to use a private communication path within the cloud provider network for traffic initiated by a function. (New) The computer-implemented method of claim 31, wherein receiving the request comprises receiving the request from one of: a function owner of the function, or a function invoker of the function.

33. The computer-implemented method of claim 31, further comprising storing an opt-in record regarding the request in an endpoint configurations data store, wherein the opt-in record specifies the function and the network-based service to which communications initiated by the function are to be communicated over the private communication path.

34. The computer-implemented method of claim 31, further comprising storing an opt-in record regarding the request in an endpoint configurations data store, wherein the opt-in record specifies that all communications initiated by the function are to be communicated over the private communication path.

35. The computer-implemented method of claim 31, further comprising:
receiving a second function invocation request to invoke a second function, wherein the second function invocation request is received from a same function invoker as the function invocation request, and wherein the request to opt-in applies to all network-based services with which functions invoked by the function invoker communicate;
generating a mapping of the network-based service to the network address of the private endpoint; and
causing execution of the second function by a virtual execution environment, wherein a second network communication to the network-based service initiated by the second function is sent to the private endpoint based on the mapping of the network-based service to the network address.

36. The computer-implemented method of claim 30, further comprising:
receiving a second function invocation request to invoke a second function, wherein the second function invocation request is received from a different function invoker than the function invocation request, and wherein no opt-in request associated with the second function has been received;
configuring a virtual execution environment to execute the second function in response to the second function invocation request; and
causing execution of the second function by the virtual execution environment, wherein a second network communication to the network-based service initiated by the second function is sent using a public network address accessible via the public internet.

37. The computer-implemented method of claim 30, wherein providing, to the host computing device, the mapping of the network-based service to the network address of the private endpoint comprises providing a mapping record to a local domain name system (DNS) server in a virtual execution environment.

38. The computer-implemented method of claim 30, further comprising routing a second communication initiated by the function to a second network-based service through an internet gateway using a public network address accessible via the public internet.

39. One or more non-transitory computer-readable media storing instructions that, when executed, cause a computing system to perform operations comprising:
receiving a function invocation request to invoke a function configured to send one or more communications to a network-based service hosted within a cloud provider network and external to an on-demand code execution system;
providing, to a host computing device configured to execute the function, a mapping of the network-based service to a network address of a private endpoint associated with the on-demand code execution system, wherein the private endpoint is configured to route network traffic within the cloud provider network using only one or more private network addresses of the cloud provider network, and wherein a public internet is not accessible via the private endpoint; and
causing execution of the function by the host computing device, wherein a network communication to the network-based service initiated by the function is sent to the private endpoint based on the mapping of the network-based service to the network address.

40. The one or more non-transitory computer-readable media of claim 39, wherein the instructions, when executed, cause the computing system to perform operations comprising:
receiving a request to opt-in to use a private communication path within the cloud provider network for traffic initiated by a function; and
storing an opt-in record regarding the request in an endpoint configurations data store, wherein the opt-in record specifies that all communications initiated by the function are to be communicated over the private communication path.
